(19) United States
(12) Patent Application Publication
(10) Pub. No.: US 2012/0002004 A1
(43) Pub. Date: Jan. 5, 2012

(54) Immersive Navigation and Rendering of Dynamically Reassembled Panoramas

(75) Inventor: Robert Mikio Free, San Jose, CA (US)

(73) Assignee: APPLE INC., Cupertino, CA (US)

(21) Appl. No.: 12/828,235

(22) Filed: Jun. 30, 2010

(51) Int. Cl. H04N 7/00

(52) U.S. Cl. 348/36; 348/E07.001

(57) ABSTRACT

Methods, systems, and apparatus, including computer programs encoded on a computer storage medium, are described for immersive navigation and for rendering of dynamically reassembled panoramas, e.g., for rendering panoramas corresponding to user specified views of a scene depicted in a captured sequence of timed digital images. By dynamically altering reassembly of panoramic slices, a viewer can in effect navigate and pivot in and about a represented space, and can experience new viewing perspectives not apparent in individual panoramic frames.

### BACKGROUND

This specification relates to immersive navigation and rendering of dynamically reassembled panoramas, and more specifically to rendering panoramas corresponding to specified views of a scene. For example, a panorama can be generated by stitching together digital images depicting a scene of interest. The digital images can be acquired from one or more locations and typically have a certain degree of overlap, e.g., in a horizontal direction. The generated panorama corresponds to a view of the scene of interest as seen by a viewer from virtual viewing points that are equivalent to locations from which the digital images were acquired.

### SUMMARY

This specification describes technologies relating to immersive navigation and rendering of dynamically reassembled panoramas, e.g., to rendering panoramas corresponding to user specified views of a scene depicted in a captured sequence of timed digital images.

In general, one aspect of the subject matter described in this specification can be implemented in methods performed by a computer system having a central processing unit (CPU) and a graphical processing unit (GPU), such that the methods include the actions of receiving, from an image capture device, and storing, in memory directly accessible by the image capture device, by the GPU and by the CPU, a sequence of timed frames having known acquisition locations. The sequence of timed frames is used by the GPU to render a panorama of a scene depicted by the sequence of timed frames. The methods also include receiving, by the CPU through a user interface, input specifying a view of the depicted scene. Further, the methods include providing, by the CPU to the GPU, slicing information for generating respective slices corresponding to the sequence of timed frames, based on (i) the known acquisition locations and on (ii) the specified view, such that respective slices corresponding to successive frames preserve a spatial continuity of the depicted scene. Furthermore, the methods include generating, by the GPU, the slices corresponding to the received frames based on the provided slicing information, and rendering, by the GPU, the panorama from the generated slices.

These and other implementations can include one or more of the following features. The slicing information includes a slice's position within a frame and a slice's width. The methods can further include outputting the rendered panorama to a graphical output device. If the user interface includes the graphical output device, and while displaying the rendered panorama to the graphical output device, then the methods further include receiving through the graphical output device another input specifying another view of the depicted scene. Further, the methods include providing, by the CPU to the GPU, slicing information corresponding to the other view, and rendering, by the GPU, another panorama corresponding to the other view of the depicted scene and outputting the other rendered panorama to the graphical output device.

For example, if the known acquisition locations include absolute geographical locations where the sequence of timed frames was respectively acquired, then the methods include obtaining the geographical locations from a geo-coordinate detector. As another example, if the known acquisition locations include relative locations where the sequence of timed frames were respectively acquired, then the methods include obtaining, from a combination of a speedometer and a compass, velocity values of the image capture device when the sequence of timed frames were respectively acquired, and integrating the obtained velocity values to determine the relative locations, respectively.

According to another aspect, the described subject matter can also be implemented in an appliance including an image capture device configured to capture timed frames. The appliance also includes a central processing unit (CPU), and a graphical processing unit (GPU). Further, the appliance includes memory directly connected to the image capture device, to the GPU and to the CPU, and configured to receive, from the image capture device, and to store the timed frames having known acquisition locations. The sequence of timed frames is used by the GPU to render a panorama of a scene depicted by the sequence of timed frames. In addition, the appliance includes a user interface configured to receive input specifying a view of the depicted scene, and to relay the received input to the CPU. The CPU is configured to access the known acquisition locations stored in the memory. Further, the CPU is configured to generate slicing information based on (i) the known acquisition locations and on (ii) the specified view, such that respective slices corresponding to successive frames preserve a spatial continuity of the depicted scene. Furthermore, the CPU is configured to provide the slicing information to the GPU. The GPU is configured to access the timed frames stored in the memory. Additionally, the GPU is configured to generate slices corresponding to the received frames based on the provided slicing information, and to render the panorama from the generated slices. The slicing information includes a slice's position within a frame and a slice's width.

These and other implementations can include one or more of the following features. The appliance further includes a graphical output device configured to output the rendered panorama. In some implementations, the user interface includes the graphical output device. The graphical output device is further configured to receive another input specifying another view of the depicted scene while outputting the rendered panorama, and then to relay the received other input to the CPU. The CPU is further configured to provide to the GPU slicing information corresponding to the other view. The GPU is further configured to render another panorama corresponding to the other view of the depicted scene, and to output the other rendered panorama to the graphical output device. For example, the graphical output device includes a touch screen display; and a receive input includes a finger-tap on the touch screen display to specify a center-facing view of the depicted scene. As another example, a received input includes a finger-swipe or a finger-drag from right to left of the touch screen display to specify a left-facing view of the depicted scene. As yet another example, a received input includes a finger-swipe or a finger-drag from left to right of the touch screen display to specify a right-facing view of the depicted scene. As a further example, a received input includes a finger-swipe or a finger-drag from top to bottom of the touch screen display to specify a far-field view of the depicted scene. Also as an example, a received input includes a finger-swipe or a finger-drag from bottom to top of the touch screen display to specify a near-field view of the depicted scene.

In some implementations, if the known acquisition locations include absolute geographical locations where the sequence of timed frames were respectively acquired, the appliance further includes a geo-coordinate detector configured to obtain the geographical locations. In some implementations, if the known acquisition locations include relative locations where the sequence of timed frames were respectively acquired, the appliance further includes a combination of a speedometer and a compass configured to obtain velocity values of the image capture device when the sequence of timed frames were respectively acquired. The velocity values include speed values provided by the speedometer and direction provided by the compass. The combination of the speedometer and the compass is further configured to integrate the obtained velocity values to determine the relative locations, respectively.

According to another aspect, the described subject matter can also be implemented in a computer storage medium encoded with a computer program. The program includes instructions that when executed by an image processing apparatus cause the image processing apparatus to perform operations including receiving three or more consecutive digital images and acquisition locations relative to a scene depicted by the received digital images. The operations further including determining an image slice for each of the received images, and creating a panorama image of the received images by combining slices of the consecutive images. The created panorama image corresponds to a specified view of the depicted scene.

These and other implementations can include one or more of the following features. Respective slices corresponding to consecutive images can be combined to preserve a spatial continuity of the depicted scene. Input to specify the view of the depicted scene is received in real time through an interface used to display the panorama corresponding to the specified view.

Particular implementations of the subject matter described in this specification can be configured so as to realize one or more of the following advantages. The effects of viewing a panorama as if turning left or right in front of a scene depicted by the panorama, and as if moving into or out of the scene depicted by the panorama can be obtained by stacking (placing one next to another) slices selected from consecutive video frames that were captured by a camera-equipped appliance, if the camera was oriented perpendicular to the scene as the appliance was moving parallel to the scene. The disclosed systems and techniques enable a viewer to effectively turn left or right in front of a panorama, or walk into or out of the panorama in real time, by selecting a slice from each of the captured frames and stacking the selected slices in real time by a GPU of the appliance.

In this fashion, the disclosed systems and techniques can provide a viewer with a virtual reality-like navigation through a sequence of video frames without having to build any geometry. In addition, by dynamically altering the reassembly of panoramic slices, the viewer can in effect navigate and pivot in and about the represented space, and can experience new perspectives not apparent in individual panoramic frames.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1J show an example of an appliance for capturing a timed sequence of digital images including information relating to position of the appliance and for rendering a panorama corresponding to a specified view of a scene depicted by the captured sequence of timed frames.

FIG. 2 shows a schematic representation of an appliance configured to render panoramas corresponding to specified views of a given scene depicted in a timed set of captured frames.

FIG. 3 shows an example of a method for rendering panoramas corresponding to specified views of a scene depicted in a timed set of acquired digital images.

FIGS. 4A and 4B show aspects of the method for rendering panoramas corresponding to the specified views of the scene.

Like reference numbers and designations in the various drawings indicate like elements.

### DETAILED DESCRIPTION

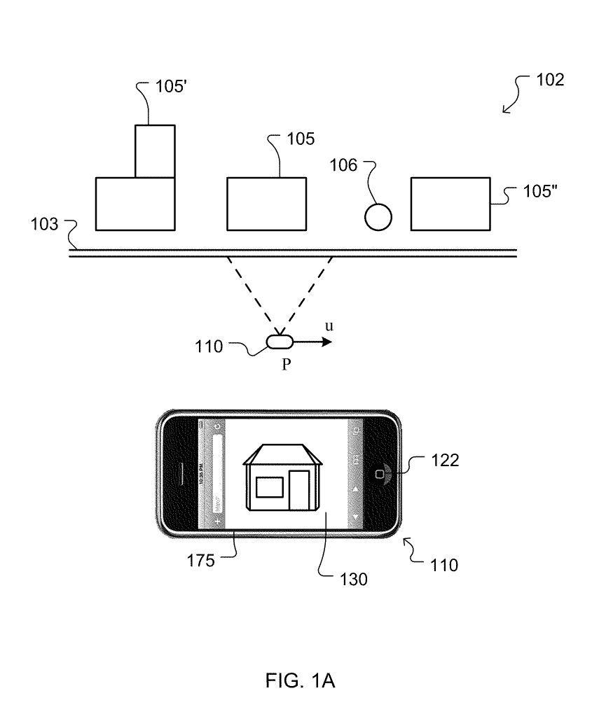

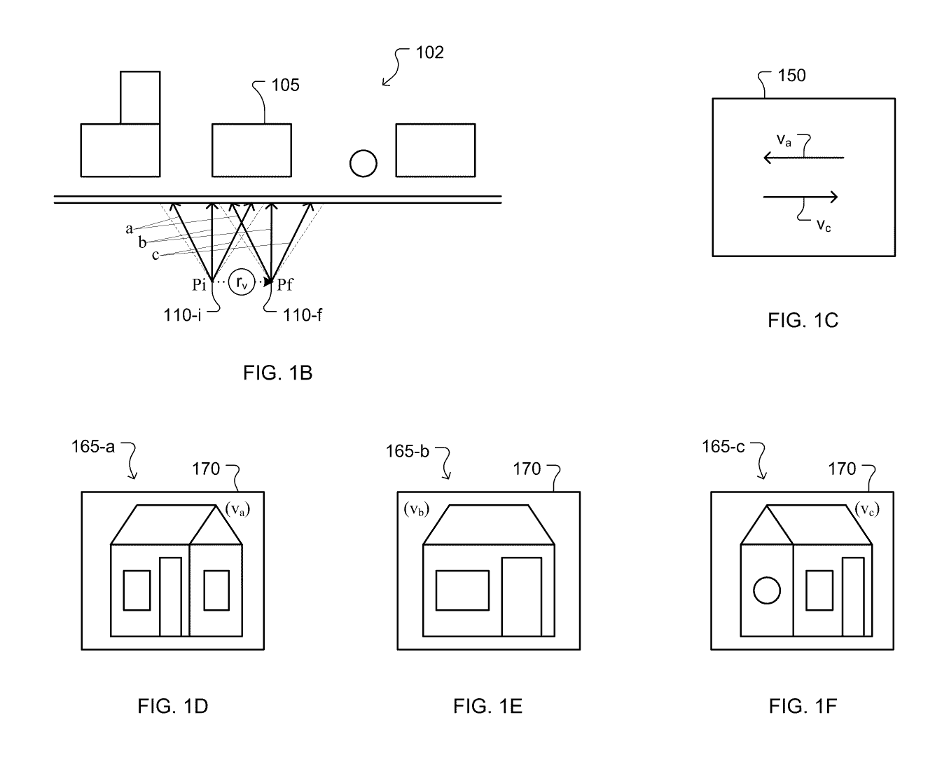

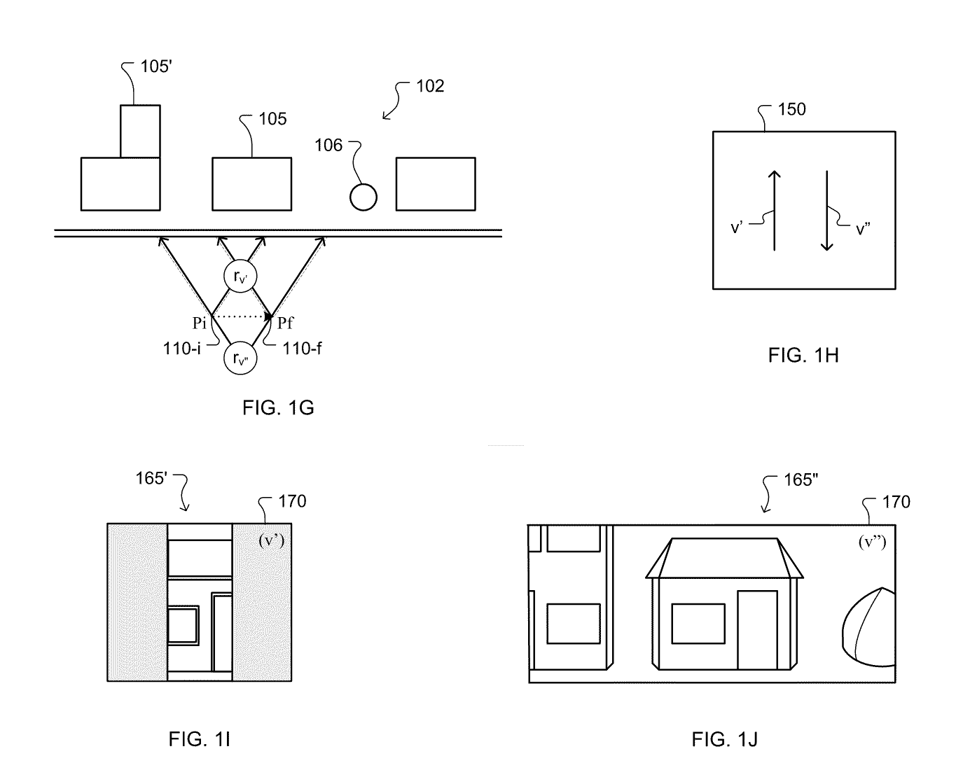

FIG. 1A shows an example of an appliance 110 that can be used for capturing digital images of a scene 102. The digital images can be part of a timed sequence of frames and can include information relating to positions of the appliance 110 when the respective frames were captured. The appliance 110 can also be used for rendering panoramas corresponding to specified views of the scene 102 depicted by the captured sequence of timed frames.

The schematic representation of the example scene 102 represents a view from above of a street including, among other things, houses 105, 105′ and 105″, and a hedge 106 located along a sidewalk 103. In this example, the appliance 110 (represented as an oval) moves parallel to the scene 102 from left to right, as indicated by a vector “u” (full line), representing the instant velocity of the appliance 110. The current location of the appliance 110 is P.

In some implementations, the appliance 110 can be a smart phone, a tablet computer or any other type of portable electronic device equipped with an image capture device. The image capture device can be a digital camera. For example, the digital camera can be a video camera for capturing multiple video frames at video capture rates. A camera input/output interface can include a video capture control 122 and a display device 175 of the appliance 110. The display device 175 can be used for displaying a captured frame 130 depicting a portion of the scene 102 (e.g., including house 105) that is currently within a field of view of the camera. The field of view is represented by an angle having an apex at the appliance 110 and having sides represented by dashed-lines. In some implementations, information relating to a location P of the appliance 110 at the time when a frame 130 from among the multiple video frames was captured is recorded by the appliance 110. In some implementations, information relating to a velocity “u” of the appliance 110 at the time when a frame 130 from among the multiple video frames was captured is recorded by the appliance 110.

FIGS. 1D, 1E and 1F show respective panoramas 165-a, 165-b and 165-c corresponding to respective views “vₐ”, “v_{b}” and “v_{c}” of a portion of the scene 102 (illustrated in FIG. 1B.) In this example, the scene 102's portion corresponds to the house 105. The panoramas 165-a, 165-b and 165-c are generated by the appliance 110 from multiple frames captured at locations Pᵢ, . . . , P_{f} between an initial location, Pᵢ, and a final location, P_{f}, of the appliance 110. The appliance 110 has been illustrated diagrammatically in FIG. 1A by an oval. Multiple instances of the oval representing the appliance 110 at locations Pᵢ, . . . , P_{f} in FIG. 1B have been omitted for clarity. A panorama 165 can be generated by selecting a slice of pixels from each captured frame and placing the selected slices adjacent to each other, such that respective selected slices corresponding to successive frames preserve a spatial continuity of the depicted scene 102. Slices from the captured frames can be selected at a given relative position within each of the multiple captured frames, such that the generated panorama 165 corresponds to a view of the scene 102 associated with the given position. The panorama 165 corresponding to the view of the scene 102 associated with the given position can be output to a graphical output device 170 of the appliance 110, as illustrated in FIGS. 1D, 1E and 1F. For example, the graphical output device 170 can be the display device 175 or a portion of the display device 175.

In FIG. 1D, a panorama 165-a corresponds to a view “vₐ” of the scene 102. The view “vₐ” of the scene 102, determined by a direction of parallel rays “a” (represented by full-arrows in FIG. 1B), extended from respective locations Pi, . . . , Pf to a left side of the associated fields of view (represented by dashed-lines in FIG. 1B) corresponding to the respective locations Pᵢ, . . . , P_{f}, is obtained by selecting a slice on the left side of each of the multiple captured frames. In FIG. 1F, a panorama 165-c corresponds to a view “v_{c}” of the scene 102. The view “v_{c}” of the scene 102, determined by a direction of parallel rays “c” extended from respective locations Pᵢ, . . . , P_{f} to a right side of the associated fields of view corresponding to the respective locations Pᵢ, . . . , P_{f}, is obtained by selecting a slice on the right side of each of the multiple captured frames. Panoramas corresponding to views of the scene 102 associated with intermediate positions with each frame can be obtained by selecting slices in between the left-most and right-most slices of each of the multiple captured frames. For example in FIG. 1E, the view “v_{b}” of the scene 102, determined by a direction of parallel rays “b” extended from respective locations Pᵢ, . . . , P_{f} to a center of the associated fields of view corresponding to the respective locations Pᵢ, . . . , P_{f}, is obtained by selecting a slice at the center of each of the multiple captured frames.

The panoramas 165-a, 165-b and 165-c shown in FIGS. 1D, 1E and 1F, respectively, corresponding to the views “vₐ”, “v_{b}” and “vₐ” of the house 105 in the scene 102, generated as described above represent what a viewer looking in the directions defined by respective rays “a”, “b” and “c” would see of the house 105 from a virtual viewing point “rᵥ” located mid-way between the initial location, Pᵢ, and the final location, P_{f}, of the appliance 110.

The views “vₐ”, “v_{b}” and “vₐ” can be specified through an input device 150 of the appliance 110 shown in FIG. 1C. For example, the display device 175 or a portion of it can be used as the input device 150, and inputs relating to specifying the scene 102's view can be provided by a user associated with the appliance 110. In some implementations when the input device 150 is a touch screen display, a default panorama 165-b may correspond to the view “v_{b}” of scene 102. The view “v_{b}” is associated with the panorama 165-b generated from the center slice of each of the multiple captured frames. In such cases, swiping or dragging from right-to-left (represented by arrow-“vₐ” pointing left) can correspond to selecting slices on the left side of each of the multiple captured frames. Multiple such leftward swipes can indicate the appliance 110 to select the leftmost slice of each frame and to generate the panorama 165-a corresponding to the view “vₐ” of the scene 102. Further, swiping or dragging from left-to-right (represented by arrow-“v_{c}” pointing right) can correspond to selecting slices on the right side of each of the multiple captured frames. Multiple such rightward swipes can indicate the appliance 110 to select the rightmost slice of each frame and to generate the panorama 165-c corresponding to the view “v_{c}” of the scene 102.

FIGS. 1I and 1J show respective panoramas 165′ and 165″ corresponding to respective views “v′” and “v″” of a portion of the scene 102 (illustrated in FIG. 1G.) The panoramas 165′ and 165″ are generated by the appliance 110 from multiple frames captured at locations Pᵢ, . . . , P_{f} between an initial location, Pᵢ, and a final location, P_{f}, of the appliance 110. The appliance 110 has been illustrated diagrammatically in FIG. 1A by an oval. Multiple instances of the oval representing the appliance 110 at locations Pᵢ, . . . , P_{f} in FIG. 1G have been omitted for clarity. As described above, a panorama 165 can be generated by selecting a slice of pixels from each captured frame and placing the selected slices adjacent to each other, such that respective selected slices corresponding to successive frames preserve a spatial continuity of the depicted scene 102.

For example, slices from the respected captured frames can be selected such that a first slice is selected on the right side of the first frame, a second slice is shifted to the left (relative to the position within the frame of the first slice) for the second frame, and so on, to a last slice which is selected on the left side of the last frame. FIG. 1I shows a panorama 165′ generated from slices selected as described above corresponding to a near-field view “v′” of the scene 102. The panorama 165′ corresponding to the near-field view “v′” of the scene 102, generated as described above, represents what a viewer would see of the scene 102 from a virtual viewing point “r_{v′}” located closer to the scene 102 by a distance “y” relative to the mid-way point between the initial location, Pᵢ, to the final location, P_{f}, of the appliance 110. The effective shift “y” towards the scene 102 is given by

$$y = \frac{x}{2 tan ( \frac{α}{2} )} , \qquad ( 1 )$$

where “x” is the distance traveled by the appliance 110 between the initial location, Pᵢ, and the final location, P_{f}, and “alpha” is the angle of the camera field of view (represented by dashed-lines in FIG. 1G.) Consequently, the effect of stepping into a panorama can be obtained by stacking slices corresponding to consecutive frames, where consecutive slices are selected at relatively increasing separations from the right-edge of the frames.

As another example, slices from the captured frames can be selected such that a first slice is selected on the left side of the first frame, a second slice is shifted to the right (relative to the position within the frame of the first slice) for the second frame, and so on, to a last slice which is selected on the right side of the last frame. FIG. 1J shows a panorama 165″ generated from slices selected as described above corresponding to a far-field view “v″” of the scene 102. The panorama 165″ corresponding to the far-field view “v″” of the scene 102, generated as described above represents what a viewer would see of the scene 102 from a virtual viewing point “r_{v″}” located farther from the scene 102 by a distance “y” relative to the mid-way point between the initial location, Pᵢ, to the final location, P_{f}, of the appliance 110. Consequently, the effect of stepping out of a panorama can be obtained by stacking slices corresponding to consecutive frames, where consecutive slices are selected at relatively increasing separations from the left-edge of frames.

The panoramas 165′ and 165″ shown in FIGS. 1I and 1J, respectively, corresponding respectively to the near-field view “v′” and the far-field view “v″” of the scene 102 can be output to a graphical output device 170 of the appliance 110. For example, the graphical output device 170 can be the display device 175 or a portion of the display device 175.

The views “v′” and “v″” can be specified through an input device 150 of the appliance 110 shown in FIG. 1H. In some implementations the input device 150 is a touch screen display 175. For example, a default image may correspond to a frame captured from a point located mid-way from the initial location, Pᵢ, to the final location, P_{f}, of the appliance 110. As another example, a default image may correspond to the panorama 165-b corresponding to the view “v_{b}” of scene 102, as illustrated in FIG. 1E. The view “v_{b}” is associated with the panorama 165-b generated from the center slice of each of the multiple captured frames. Swiping or dragging from bottom-to-top (represented by arrow-“v” pointing up) can correspond to requests for panoramas corresponding to near-field views “v′” of the scene 102. Further, swiping or dragging from top-to-bottom (represented by arrow-“v” pointing down) can correspond to requests for panoramas corresponding to far-field views “v” of the scene 102.

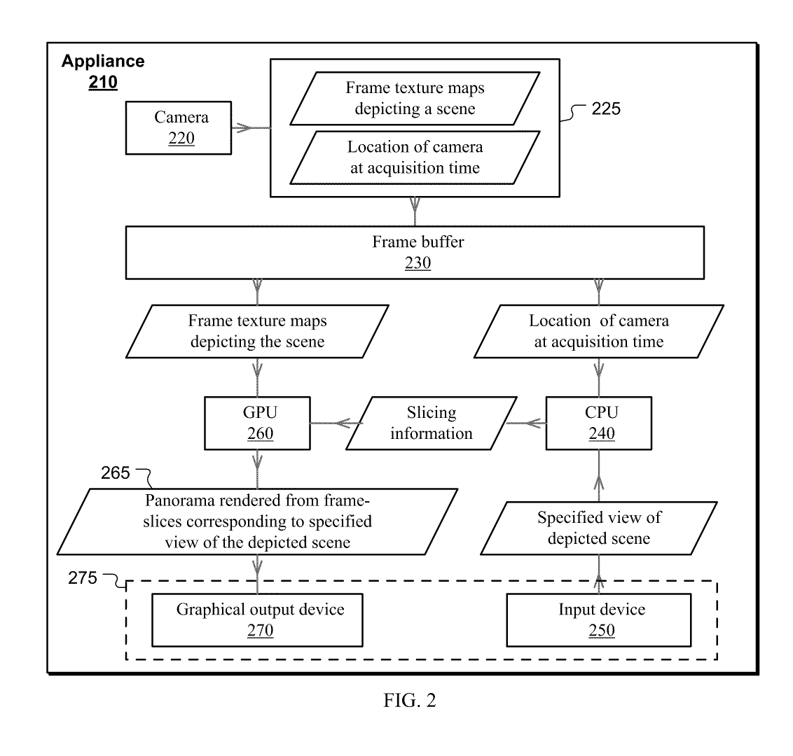

FIG. 2 shows a schematic representation of an appliance 210 configured to acquire a sequence of timed frames and to render panoramas corresponding to specified views of a scene depicted by the acquired frames. In some implementations, the appliance 210 can be implemented as the portable electronic device 110 described in connection with FIG. 1 and can render panoramas corresponding to at least the views “va”, “vb” and “vc”, and “v′” and “v″” of scene 102.

The appliance 210 includes an image capture device 220, e.g., a digital camera, coupled with an image buffer 230. A central processing unit (CPU) 240 and a graphical processing unit (GPU) 260 of the appliance 210 share the image buffer 230 with the camera 220. The appliance 210 further includes an input device 250 and a graphical output device 270. Optionally, the input device 250 and the graphical output device 270 are integrated into one device 275, e.g., a touch screen display.

The appliance 210 can capture a sequence of timed frames depicting a given scene using the camera 220. For example, the camera 220 can be a video camera configured to acquire frames at video rates. Additionally, the output 225 of the camera 220 includes, for each of the captured frames, a texture map depicting a portion of the given scene and location information. In some implementations, information corresponding to absolute locations of the appliance 210 when the frames were captured can be obtained from a geo-coordinate detector included in the appliance 210. For example, the geo-coordinate detector can receive location information from a GPS. As another example, the geo-coordinate detector can obtain location information from a cell phone network. In some implementations, information corresponding to relative locations of the appliance 210 when the frames were captured can be obtain by integrating a timed sequence of speed measurements obtained by a speedometer communicatively coupled with the appliance 210. For example, a distance, Δx, traveled by the appliance 210 between consecutive frame acquisitions can be determined by multiplying a time interval, Δt, between consecutive frame acquisitions and an average speed, u, over the time interval, i.e., Δx=u*Δt.

The output 225 of the camera 220 is transferred to the image buffer 230 such that both the GPU 260 and the CPU 240 have direct access to it. Additionally, the appliance 210 receives input through the input device 250 specifying a view of the given scene depicted in the captured frames to which a panorama rendered by the GPU 260 should correspond. In some implementations corresponding to the mobile electronic device 110 shown in FIG. 1A, the input device 270 corresponds to the input device 150 (shown in FIGS. 1C and 1H) implemented as a touch screen display 175 for receiving instructions specifying a left-facing view “vₐ”, a center-facing view “v_{b}”, and right-facing view “v_{c}” of the depicted scene 102, and specifying a near-field view “v′” or a far-field view “v″” of the depicted scene 102.

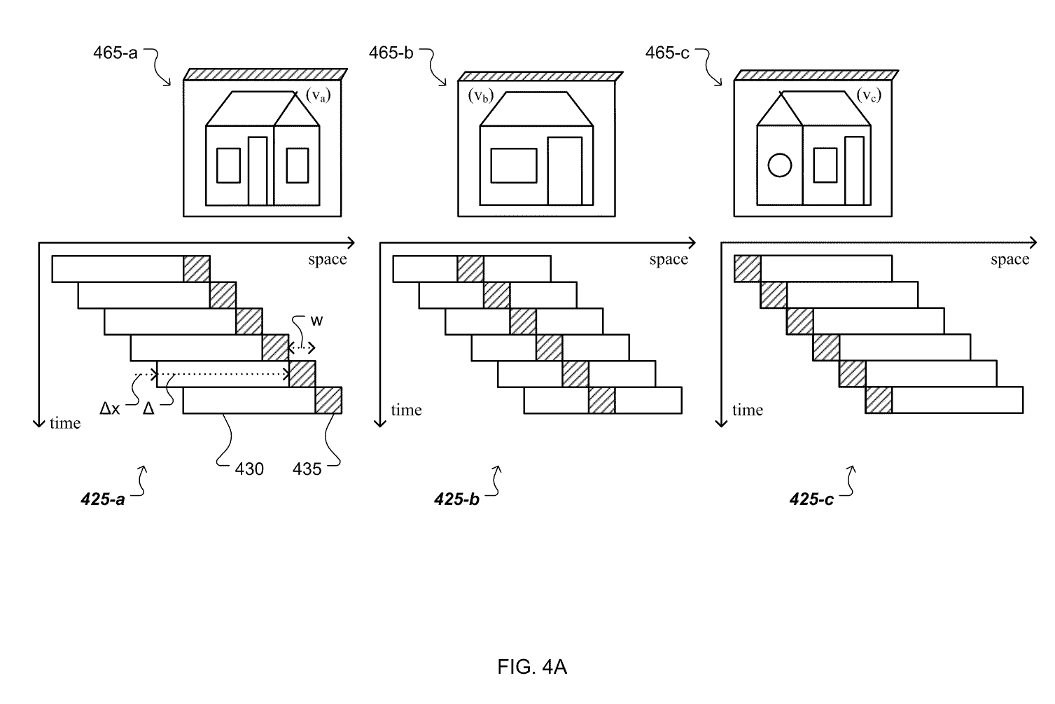

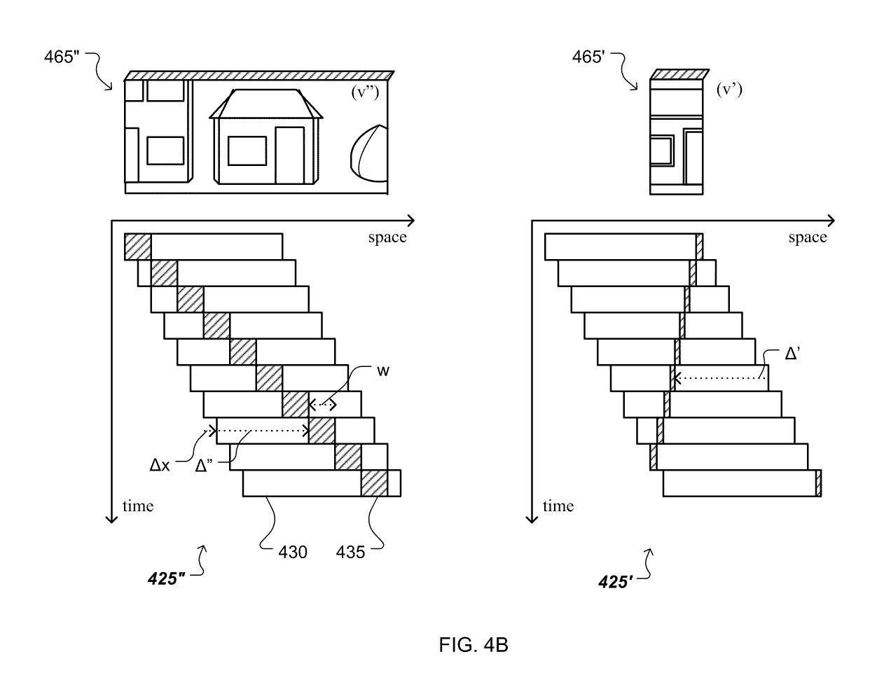

The CPU 240 can use (i) the location information corresponding to each of the captured frames and (ii) the specified view of the given scene to determine slicing information for relaying to the GPU 260. The slicing information includes at least a width and a position of a slice within each captured frame. For example, the CPU 240 can determine the slice position within each captured frame according to the slice selection procedures described above in connection with FIGS. 1B and 1G. Other techniques used by the CPU 240 for determining the slice width and the slice position within each captured frame are described in detail below in connection with FIGS. 4A and 4B.

The GPU 260 accesses (I) the texture maps of the captured frames depicting the given scene from the image buffer 230 and obtains (II) the slicing information from the CPU 240 to render a panorama corresponding to the specified view of the given scene. The rendered panorama 265 corresponding to the specified view can be provided by the GPU 260 for presentation to the graphical output device 270. In some implementations corresponding to the mobile electronic device 110 shown in FIG. 1A, the graphical output device 270 can be a touch screen display 175.

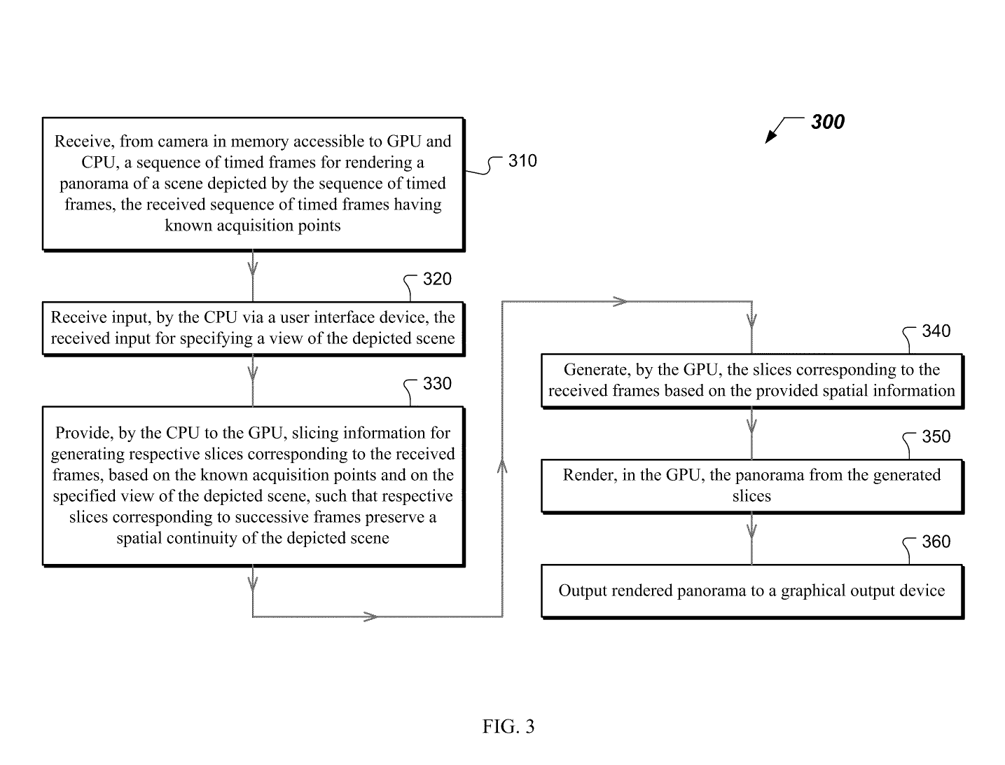

FIG. 3 shows an example of a method 300 for rendering panoramas corresponding to specified views of a scene depicted in captured timed frames. In some implementations, the method 300 can be implemented by a mobile electronic device 110 as shown in FIG. 1A and/or by an appliance 210 as shown in FIG. 2.

The method 300 includes receiving 310, from an image capture device, and storing, in memory accessible to a graphical processing unit (GPU) and to a central processing unit (CPU), a sequence of timed frames having known acquisition locations. The received sequence of timed frames can be used for rendering a panorama of a scene depicted by the sequence of timed frames.

The method 300 further includes receiving 320 input, by the CPU through a user interface device. The received input specifies a view of the depicted scene.

Further, the method 300 includes providing 330, to the GPU by the CPU, slicing information for generating respective slices corresponding to the received sequence of timed frames, based on (i) the known acquisition points and on (ii) the specified view of the depicted scene, such that respective slices corresponding to successive frames preserve a spatial continuity of the depicted scene. In some implementations, the slicing information includes a slice's position within a frame and a slice's width.

Furthermore, the method 300 includes generating 340, by the GPU, the slices corresponding to the received frames based on the provided slicing information. The method 300 also includes rendering 350 the panorama from the generated slices, by the GPU. In some implementations, the method 300 can also include outputting 360 the rendered panorama to a graphical output device.

FIGS. 4A and 4B show aspects of the method 300 for rendering panoramas corresponding to specified views of a given scene. To render a panorama 465 corresponding to a specified view of the given scene, a graphical processing unit (GPU) can access respective texture maps of frames 425 acquired at video rates which depict the given scene. The frames 425 are represented in a space-time coordinate system. Early frames are closer to the space and time origin at the upper-left corner of the space-time coordinate system. Later frames are down-shifted in a direction of increasing time, such that two consecutively acquired frames are separated by a temporal interval Δt. For frame acquisition at video rates, Δt can be constant. Additionally for this example, later frames are right-shifted along a direction of appliance's travel. Two consecutively acquired frames are separated by a spatial interval Δx. In some implementations, Δx is determined as a distance between absolute locations Pj and Pj+1 corresponding to known locations of consecutive acquisition points. In other implementations, Δx is determined as a product between the appliance's speed “u” and Δt, Δx=uΔt.

As described above, the GPU isolates slices of the texture maps 425 to render from the isolated slices a panorama that preserves a spatial continuity of the given scene and corresponds to the specified view of the given scene. Slicing information including a location Δ of a slice 435 of width “w” within a frame 430 is determined such that the isolated slices satisfy the foregoing requirements. The determination of slicing information can be performed by a central processing unit (CPU) and once determined, the slicing information can be relayed to the GPU.

FIG. 4A shows slicing of the acquired texture maps 425-a, 425-b and 425-c for rendering respective panoramas 465-a, 465-b and 465-c corresponding to a left-facing view “vₐ”, a center-facing view “v_{b}” and a right-facing view “v_{c}” of the given scene. These panoramas can be rendered by the GPU from slices 435 of width w=Δx that are isolated from each frame 430 at a distance Δ measured from the left end of each frame 430. In the case of the panorama 465-a corresponding to the left-facing view “vₐ”, Δ can equal a width of the frame 430 minus the width of the slice w. In the case of the panorama 465-b corresponding to the center-facing view “v_{b}”, Δ can equal a half-width of the frame 430 minus a half of the width of the slice, w/2. In the case of the panorama 465-a corresponding to the right-facing view “v_{c}”, Δ can equal zero, i.e., the GPU isolates the first slice at the left side of a frame 430 for each of the texture maps 425-c.

FIG. 4B shows slicing of the acquired texture maps 425′ and 425″ for rendering respective panoramas 465′ and 465″ corresponding to a near-field view “v′” and a far-field view “v″” of the given scene. For example, the panorama 465″ corresponding to the far-field view “v″” can be rendered by the GPU from slices 435 of width w=2Δx that are isolated from frames 430 at distances Δ″ⱼ measured from the left end of frames 430-j that increase relative to distances Δ″ⱼ₋₁ corresponding to the previously acquired frames 430-(j−1) by Δ″ⱼ−Δ″ⱼ₋₁=w−Δx. (j=1, 2, . . . , N, where N is the number of acquired frames) As another example, the panorama 465′ corresponding to the near-field view “v′” can be rendered by the GPU from slices 435 of width w=Δx/2 that are isolated from frames 430 at distances Δ″ⱼ measured from the right end of frames 430-j that increase relative to distances Δ″ⱼ₋₁ corresponding to the previously acquired frames 430-(j−1) by Δ″ⱼ−Δ″ⱼ₋₁=w+Δx.

A multitude of computing devices may be used to implement the systems and methods described in this document, as either a client or as a server or plurality of servers. A computing device can be implemented in various forms of digital computers, such as laptops, desktops, workstations, personal digital assistants, servers, blade servers, mainframes, and other appropriate computers. Another computing device can be implemented in various forms of mobile devices, such as personal digital assistants, cellular telephones, smartphones, and other similar computing devices. Additionally, computing devices can include Universal Serial Bus (USB) flash drives. The USB flash drives may store operating systems and other applications. The USB flash drives can include input/output components, such as a wireless transmitter or USB connector that may be inserted into a USB port of another computing device. The components described here, their connections and relationships, and their functions, are meant to be exemplary only, and are not meant to limit implementations of the inventions described and/or claimed in this document.

A computing device can include a processor, memory, a storage device, a high-speed interface connecting to memory and high-speed expansion ports. The computing device can further include a low speed interface connecting to a low speed bus and a storage device. Each of the above components can be interconnected using various busses, and may be mounted on a common motherboard or in other manners as appropriate. The processor can process instructions for execution within the computing device, including instructions stored in the memory or on the storage device to display graphical information for a GUI on an external input/output device, such as a display coupled to high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory can store information within the computing device. In one implementation, the memory can be a volatile memory unit or units. In another implementation, the memory can be a non-volatile memory unit or units. The memory may also be another form of computer-readable medium, such as a magnetic or optical disk.

The storage device can provide mass storage for the computing device. In one implementation, the storage device may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier is a computer- or machine-readable medium, such as the memory, the storage device, or memory on processor.

The high speed controller can manage bandwidth-intensive operations for the computing device, while the low speed controller can manage lower bandwidth-intensive operations. Such allocation of functions is exemplary only. In one implementation, the high-speed controller can be coupled to memory, to a display (e.g., through a graphics processor or accelerator), and to high-speed expansion ports, which may accept various expansion cards. In the implementation, low-speed controller can be coupled to the storage device and the low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms. For example, it may be implemented as a standard server, or multiple times in a group of such servers. It may also be implemented as part of a rack server system. In addition, it may be implemented in a personal computer such as a laptop computer. Alternatively, components from computing device may be combined with other components in a mobile device. Each of such devices may contain one or more computing devices or mobile devices, and an entire system may be made up of multiple computing devices and mobile devices communicating with each other.

A mobile device can include a processor, memory, an input/output device such as a display, a communication interface, and a transceiver, among other components. The mobile device may also be provided with a storage device, such as a microdrive or other device, to provide additional storage. Each of the above components is interconnected using various buses, and several of the components may be mounted on a common motherboard or in other manners as appropriate.

The processor can execute instructions within the mobile device, including instructions stored in the memory. The processor of the mobile device may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the mobile device, such as control of user interfaces, applications run by the mobile device, and wireless communication by the mobile device.

The processor of the mobile device may communicate with a user through control interface and display interface coupled to a display. The display may be, for example, a Thin-Film-Transistor Liquid Crystal display or an Organic Light Emitting Diode display, or other appropriate display technology. The display interface may include appropriate circuitry for driving the display to present graphical and other information to a user. The control interface may receive commands from a user and convert them for submission to the processor of the mobile device. In addition, an external interface may provide in communication with processor of the mobile device, so as to enable near area communication of the mobile device with other devices. The external interface may provide, for example, for wired communication in some implementations, or for wireless communication in other implementations, and multiple interfaces may also be used.

The memory stores information within the computing mobile device. The memory can be implemented as one or more of a computer-readable medium or media, a volatile memory unit or units, or a non-volatile memory unit or units. An expansion memory may also be provided and connected to the mobile device through an expansion interface, which may include, for example, a SIMM (Single In Line Memory Module) card interface. Such expansion memory may provide extra storage space for the mobile device, or may also store applications or other information for the mobile device. Specifically, expansion memory may include instructions to carry out or supplement the processes described above, and may include secure information also. Thus, for example, expansion memory may be provide as a security module for the mobile device, and may be programmed with instructions that permit secure use of device. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly implemented in an information carrier. The computer program product contains instructions that, when executed, perform one or more methods, such as those described above. The information carrier is a computer- or machine-readable medium, such as the memory, expansion memory, or memory on processor that may be received, for example, over transceiver or external interface.

The mobile device may communicate wirelessly through communication interface, which may include digital signal processing circuitry where necessary. Communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver. In addition, short-range communication may occur, such as using a Bluetooth, WiFi, or other such transceiver (not shown). In addition, GPS (Global Positioning System) receiver module may provide additional navigation- and location-related wireless data to the mobile device, which may be used as appropriate by applications running on the mobile device.

The mobile device may also communicate audibly using audio codec, which may receive spoken information from a user and convert it to usable digital information. Audio codec may likewise generate audible sound for a user, such as through a speaker, e.g., in a handset of the mobile device. The sound may include sound from voice telephone calls, may include recorded sound (e.g., voice messages, music files, etc.) and may also include sound generated by applications operating on the mobile device.

The mobile computing device may be implemented in a number of different forms. For example, it may be implemented as a cellular telephone. It may also be implemented as part of a smartphone, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a computer system having a central processing unit (CPU) and a graphical processing unit (GPU), the method comprising:
receiving, from an image capture device, and storing, in memory directly accessible by the image capture device, by the GPU and by the CPU, a sequence of timed frames having known acquisition locations, the sequence of timed frames for rendering a panorama of a scene depicted by the sequence of timed frames;
receiving, by the CPU through a user interface, input specifying a view of the depicted scene;
providing, by the CPU to the GPU, slicing information for generating respective slices corresponding to the sequence of timed frames, based on (i) the known acquisition locations and on (ii) the specified view, such that respective slices corresponding to successive frames preserve a spatial continuity of the depicted scene;
generating, by the GPU, the slices corresponding to the received frames based on the provided slicing information; and
rendering, by the GPU, the panorama from the generated slices.

2. The method of claim 1, wherein the slicing information includes a slice's position within a frame and a slice's width.

3. The method of claim 1, further comprising outputting the rendered panorama to a graphical output device.

4. The method of claim 3, wherein the user interface comprises the graphical output device, the method further comprising:
while displaying the rendered panorama to the graphical output device, receiving through the graphical output device another input specifying another view of the depicted scene;
providing by the CPU to the GPU slicing information corresponding to the other view; and
rendering by the GPU another panorama corresponding to the other view of the depicted scene and outputting the other rendered panorama to the graphical output device.

5. The method of claim 1, wherein the known acquisition locations comprise absolute geographical locations where the sequence of timed frames were respectively acquired, the method comprising obtaining the geographical locations from a geo-coordinate detector.

6. The method of claim 1, wherein the known acquisition locations comprise relative locations where the sequence of timed frames were respectively acquired, the method comprising:
obtaining, from a combination of a speedometer and a compass, velocity values of the image capture device when the sequence of timed frames were respectively acquired; and
integrating the obtained velocity values to determine the relative locations, respectively.

7. An appliance comprising:
an image capture device configured to capture timed frames;
a central processing unit (CPU);
a graphical processing unit (GPU);
memory directly connected to the image capture device, to the GPU and to the CPU, and configured to perform operations comprising:
receiving, from the image capture device, and storing the timed frames having known acquisition locations, the sequence of timed frames for rendering a panorama of a scene depicted by the sequence of timed frames;
a user interface configured to perform operations comprising:
receiving input specifying a view of the depicted scene;
relaying the received input to the CPU;
the CPU configured to perform operations comprising:
accessing the known acquisition locations from the memory;
generating slicing information based on (i) the known acquisition locations and on (ii) the specified view, such that respective slices corresponding to successive frames preserve a spatial continuity of the depicted scene; and
providing the slicing information to the GPU;
the GPU configured to perform operations comprising:
accessing the timed frames from the memory;
generating slices corresponding to the received frames based on the provided slicing information; and
rendering the panorama from the generated slices.

8. The appliance of claim 7, wherein the slicing information includes a slice's position within a frame and a slice's width.

9. The appliance of claim 7, further comprising:
a graphical output device configured to perform operations comprising:
outputting the rendered panorama.

10. The appliance of claim 9, wherein:
the user interface comprises the graphical output device, and wherein the graphical output device is further configured to perform operations comprising:
while outputting the rendered panorama, receiving another input specifying another view of the depicted scene;
relaying the received other input to the CPU;
the CPU is further configured to perform operation comprising:
providing to the GPU slicing information corresponding to the other view;
the GPU is further configured to perform operation comprising:
rendering another panorama corresponding to the other view of the depicted scene; and
outputting the other rendered panorama to the graphical output device.

11. The appliance of claim 10, wherein:
the graphical output device comprises a touch screen display; and
an input comprises a finger-tap on the touch screen display to specify a center-facing view of the depicted scene.

12. The appliance of claim 11, wherein an input comprises a finger-swipe or a finger-drag from right to left of the touch screen display to specify a left-facing view of the depicted scene.

13. The appliance of claim 11, wherein an input comprises a finger-swipe or a finger-drag from left to right of the touch screen display to specify a right-facing view of the depicted scene.

14. The appliance of claim 11, wherein an input comprises a finger-swipe or a finger-drag from top to bottom of the touch screen display to specify a far-field view of the depicted scene.

15. The appliance of claim 11, wherein an input comprises a finger-swipe or a finger-drag from bottom to top of the touch screen display to specify a near-field view of the depicted scene.

16. The appliance of claim 7, wherein the known acquisition locations comprise absolute geographical locations where the sequence of timed frames were respectively acquired, the appliance further comprising:
a geo-coordinate detector configured to perform operations comprising:
obtaining the geographical locations.

17. The appliance of claim 7, wherein the known acquisition locations comprise relative locations where the sequence of timed frames were respectively acquired, the appliance further comprising:
a combination of a speedometer and a compass configured to perform operations comprising:
obtaining velocity values of the image capture device when the sequence of timed frames were respectively acquired, wherein the velocity values include speed values provided by the speedometer and direction provided by the compass; and
integrating the obtained velocity values to determine the relative locations, respectively.

18. A computer storage medium encoded with a computer program, the program comprising instructions that when executed by an image processing apparatus cause the image processing apparatus to perform operations comprising:
receiving three or more consecutive digital images and acquisition locations relative to a scene depicted by the received digital images;
determining an image slice for each of the received images; and
creating a panorama image of the received images by combining slices of the consecutive images,
wherein the created panorama image corresponds to a specified view of the depicted scene.

19. The computer storage medium of claim 18, wherein respective slices corresponding to consecutive images are combined to preserve a spatial continuity of the depicted scene.

20. The computer storage medium of claim 18, wherein input to specify the view of the depicted scene is received in real time through an interface used to display the panorama corresponding to the specified view.
